(19) United States
(12) Patent Application Publication
(10) Pub. No.: US 2010/0299418 A1
(43) Pub. Date: Nov. 25, 2010

(54) CONFIGURATION AND ADMINISTRATIVE CONTROL OVER NOTIFICATION PROCESSING IN OMA DM

(75) Inventor: Kong Posh Bhat, Plano, TX (US)

Correspondence Address: Docket Clerk, P.O. Drawer 800889, Dallas, TX, 75380, US

(73) Assignee: Samsung Electronics Co., Ltd., Suwon-si (KR)

(21) Appl. No.: 12/753,612

(22) Filed: Apr. 2, 2010

Related U.S. Application Data
(60) Provisional application No. 61/216,921, filed on May 22, 2009.

(51) Int. Cl. G06F 15/173; G06F 15/177; G06F 15/16

(52) U.S. Cl. 709/221; 709/223; 709/227

(57) ABSTRACT

A method and a device are configured to receive a signal from a server to perform administrative and configuration control. During Open Mobile Alliance (OMA) Device Management (DM) session, the device receives either an administrative or configuration signal from the server. The administrative signal may instruct the device to inhibit or allow a trigger processing capability. The configuration signal may instruct the device to apply a set of parameters to the device settings that are related to notification processing.

### CROSS-REFERENCE TO RELATED APPLICATION(S) AND CLAIM OF PRIORITY

The present application is related to U.S. Provisional Patent Application No. 61/216,921, filed May 22, 2009, entitled “CONFIGURATION AND ADMINISTRATIVE CONTROL OVER NOTIFICATION PROCESSING IN OMA DM”. Provisional Patent Application No. 61/216,921 is assigned to the assignee of the present application and is hereby incorporated by reference into the present application as if fully set forth herein. The present application hereby claims priority under 35 U.S.C. §119(e) to U.S. Provisional Patent Application No. 61/216,921.

### TECHNICAL FIELD OF THE INVENTION

The present application relates generally to Open Mobile Alliance-Device Management (OMA-DM) and, more specifically, to configuration and administrative control over notification processing in OMA-DM.

### BACKGROUND OF THE INVENTION

Open Mobile Alliance (OMA) Device Management (DM) is a two-way management protocol between a server and a client device that was initially designed for remote management of small mobile devices such as personal digital assistants (PDAs), mobile phones, and such. The purpose of OMA DM is to provide protocols and mechanisms for management of a client device. Management includes, inter alia, setting initial configuration information in devices, subsequent installation and updates of persistent information in devices, retrieval of management information from devices, and processing events and alarms generated by devices.

To establish an OMA DM management session, the server transmits a trigger or alert (also known as Package 0) to the client. Upon recognizing the trigger, the client device immediately initiates the OMA DM session with the server. So the trigger can come from the server, but the actual initiation of the session is performed by the client device.

Previously, in DM Release 1.2, the trigger was usually delivered through a wireless application protocol (WAP) Push. Short message serve (SMS) has been used most commonly to deliver the trigger as a specially formatted message to the device. This system worked quite well as long as OMA DM was being used for management of PDAs and cell phones, which all had a mechanism for receiving SMS.

In the current DM Release 1.3, OMA DM has been expanded to provide management solutions for other types of devices—such as laptop computers, desktop computers, and virtually any device that has communication capabilities—that may lack the capability to receive SMS. To that end, DM Release 1.3 introduced a new binding for delivering the trigger to the client device based on session initiation protocol (SIP). And, perhaps, future Releases might also incorporate user datagram protocol (UDP).

While the mechanism for trigger (i.e. Package 0) processing in DM Release 1.2 obviated the need for a client device to continuously listen for connections, new bindings (such as SIP and UDP) for triggering devices that are not capable of receiving SMS will require client devices to listen on some pre-defined port number.

As DM expands to accommodate more device types and using SIP (in DM Release 1.3) and other bindings (e.g. UDP in future releases), client devices will become vulnerable to Denial-of-Service (DoS) attacks. This is because client devices currently process every trigger to initiate a DM session, and there are no means for a server to remotely inhibit or modify trigger processing in the client device.

Therefore, there is a need in the art for remotely inhibiting or modifying trigger processing in the client device. In particular, there is a need for a method and apparatus that provides administrative and configuration control over trigger processing in OMA DM.

### SUMMARY OF THE INVENTION

In one embodiment, a method for use in a client device during a remote management session with a server is provided. The method comprises receiving an administrative signal from the server and disabling a trigger processing capability in the device when the administrative signal notifies the device to inhibit trigger processing.

In some embodiments, the method further comprises receiving a configuration signal from the server and applying a set of parameters included in the configuration signal to the DM settings.

In another embodiment, a device that is capable of conducting a remote management session with a server is provided. The device is configured to receive an administrative signal from the server and inhibit a trigger processing capability in the device when the administrative signal notifies the device to inhibit trigger processing.

In some embodiments, the device is further configured to receive a configuration signal from the server and apply a set of parameters included in the configuration signal to the device settings.

In some embodiments, the remote management session is an OMA DM session and trigger processing comprises initiating the OMA DM session.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network topology view of the device management system in which the present disclosure may be implemented;

FIG. 2 illustrates a two-way protocol between a server and a client according to the principles of the present disclosure;

FIG. 3 illustrates an example management structure that includes administrative and configuration control for trigger processing according to an embodiment of the present disclosure;

FIG. 4 illustrates a process in a client device during a device management session according to an embodiment of the disclosure; and

FIG. 5 illustrates a process in which a client may ignore trigger signals according to an embodiment of the present disclosure.

### DETAILED DESCRIPTION OF THE INVENTION

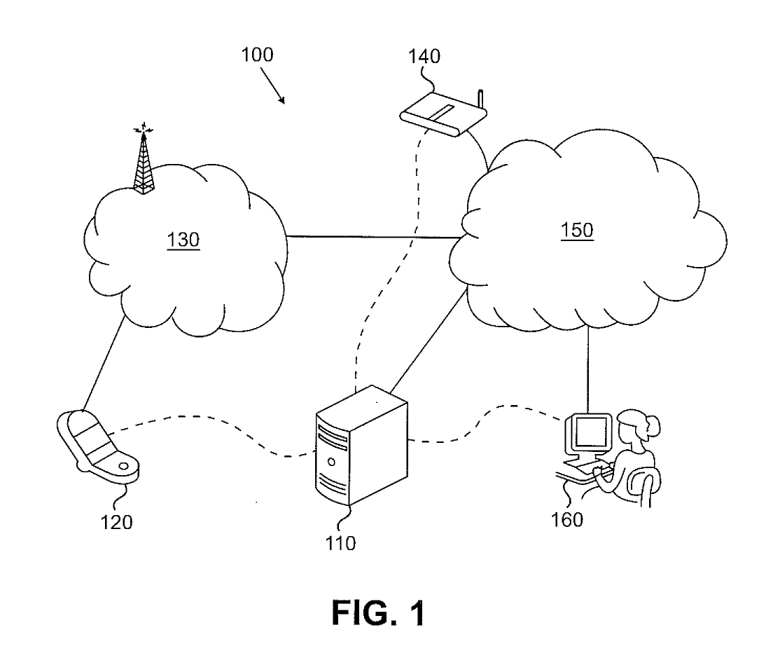

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged client device that is capable of being remotely managed by a server.

FIG. 1 illustrates a network topology view of the device management system in which the present disclosure may be implemented.

Solid lines represent physical connectivity and dotted lines represent logical connectivity. The DM protocol runs between the DM server 110 and the wireless device 120 in the cellular network 130. The DM protocol also runs between the DM server 110 and the wired device 140 that is connected to the Internet 150. An operations support system (OSS) 160 directs the device management operations on the target devices via the DM server 110. Wireless device 120 and wired device 140 may be any device that is capable of connecting to a cellular network or to the Internet 150.

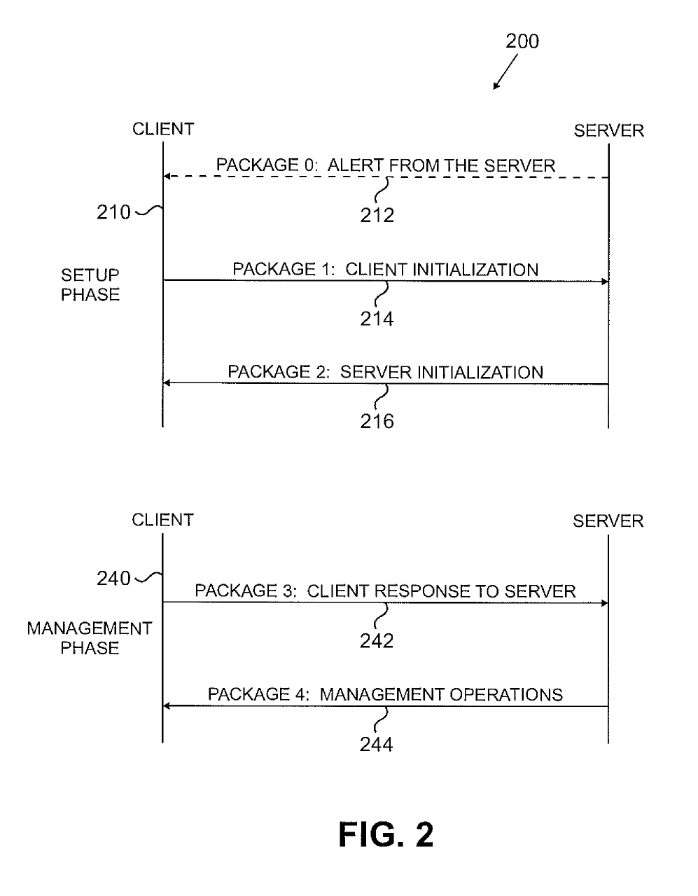

FIG. 2 illustrates a two-way protocol of Open Mobile Alliance (OMA) Device Management (DM) between a server and a client according to the principles of the present disclosure.

The protocol consists of two phases: the setup phase 210 and the management phase 240. During setup phase 210, the client and the server transmit authentication and information exchange packages. The client may be wireless device 120 or wired device 140, and the server may be DM server 110. For the purpose of disclosure, the packages transmitted between the client and the server during the operations will be referred to as messages.

The trigger signal 212 (Package ‘0’) may be viewed as a “wakeup call” from the server to the client in order to establish a management session. In DM 1.2, trigger signal 212 was delivered through a wireless application protocol (WAP) Push, in which short message service (SMS) has been the most commonly used method for delivering this message to the device. DM 1.2 also used an Object Exchange (OBEX) binding for delivering trigger signal 212, but that has not been used sparingly. DM 1.3 incorporates session initiation protocol (SIP) as a new binding for delivering trigger signal 212.

Upon receiving trigger signal 212, the client initiates a management session with the server by transmitting client initialization message 214 (Package ‘1’) to the server. Prior to that, the client may verify whether the triggering server is included among the list of valid management servers. The list of valid management servers may be bootstrapped to the client device. Client initialization message 214 includes client credentials and device information of the client. Upon receiving client initialization message 214, the server transmits server initialization message 216 (Package ‘2 ’) to the client. Server initialization message 216 includes server credentials, initial management operations or user interaction commands from the server.

During the management phase 240, the client and the server exchange packages related to various management operations. Assuming server initialization message 216 included an initial management operation or a user interaction command, the client transmits a response message 242 (Package ‘3 ’) to the server. Response message 242 may acknowledge the management operation or provide a result status of the management operation. Subsequent user interaction commands or management operations may be transmitted from the server to the client in management operations message 244 while the management session is continued. The client may transmit a corresponding response message 242 for each subsequent management operations message 244.

The user interaction commands and management operations are conducted during a remote management of the device through a management protocol, such as OMA DM. The user interaction commands and management operations may be associated with administrative and configuration control over trigger signal 212 processing in the client device.

Administrative control refers to the ability to inhibit a client device, such as wireless device 120 and wired device 140, from processing the trigger signal 212 received from a server, such as DM server 110. When trigger processing is inhibited in the client device, trigger signals sent from a server to the client device are ignored. As such, the client device does not initiate a management session with the server. When trigger processing is inhibited in the client device, only the client can initiate the management session at the time of its choosing. The client device may schedule a particular time to initiate a management session or periodically initiate subsequent management session to check whether the server needs to perform management operations. Currently, this level of control is absent in OMA DM.

Additionally, trigger processing can be inhibited for any particular binding, such as WAP, SIP, or UDP. For example, trigger processing may be inhibited for WAP and UDP, but allowed for SIP. The client device will ignore trigger signals 212 that are delivered through WAP and UDP, but process a trigger signal 212 that is delivered through SIP.

Configuration control refers to the ability to change the manner in which the client device can listen for connections. Configuration control also varies with respect to the binding (e.g. SIP, UDP). For SIP, configuration control can change the public identity of the client device and the port number at which the client device can listen for trigger signal 212. For UDP, configuration control can change the listening port number. For WAP Push, which uses SMS for delivering trigger signal 212, configuration control is not supported.

It is worth mentioning that the trigger signal 212 is an OMA DM notification message that is based on OMA Push. DMA Push is the underlying technology for pushing any content to a device over any transport. OMA Push technology, itself, is largely unaware of the underlying protocol but has transport bindings. As such OMA Push has transport bindings that are different protocols (e.g. WAP, SIP, and HTTP, and such) and can add new transport bindings. When pushing content to a device, the server sends the content through a push proxy gateway, which sends the content to the device.

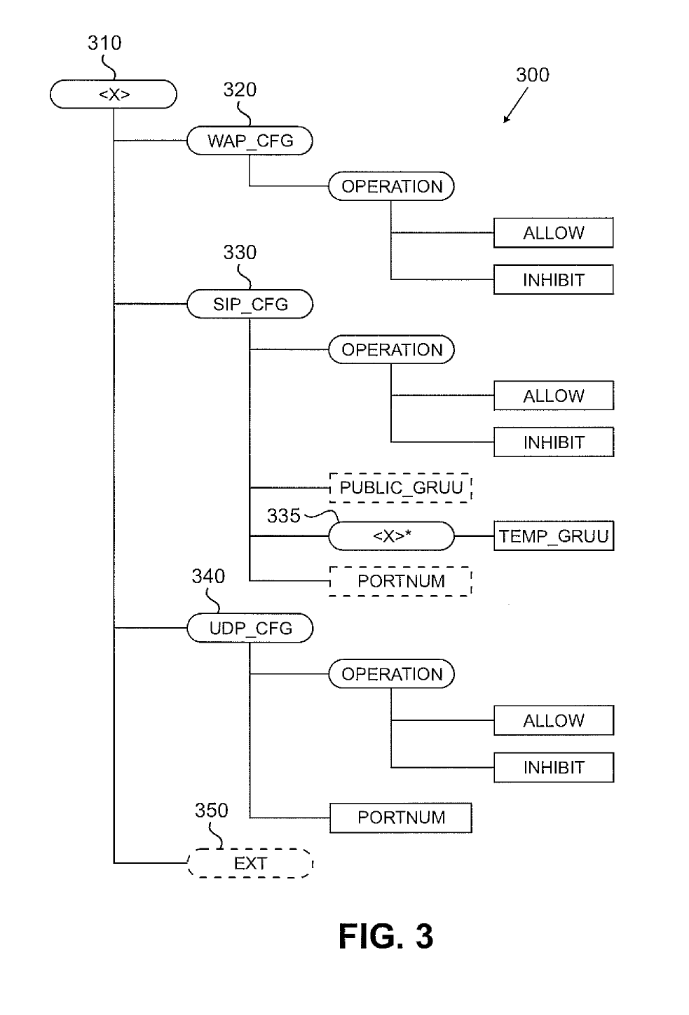

FIG. 3 illustrates an example management structure that includes administrative and configuration control for trigger processing according to an embodiment of the present disclosure.

Management structure 300, which is shown as having a tree structure, is merely an illustrative representation of the administrative and configuration control disclosed in the present disclosure and is not meant to limit the scope of the disclosure to any particular embodiment.

Management structure 300 may be an access interface to a suite of functions for administrative and configuration control of a client device. Alternatively, management structure 300 may be implemented as an added capability to an existing management object. Still further, management structure 300 maybe be implemented as a new management object. The interior nodes of management structure 300 are shown with rounded rectangles while the leaf nodes are shown with normal rectangles. All the required nodes have a solid border while the optional nodes have a dotted border. Additionally, nodes labeled ‘<X>’ are called “placeholder nodes” and they are assigned names at run time, generally by the DM Server, and nodes with an asterisk (“*”) indicate there may be more occurrences. For the situation in which management structure 300 is a management object, the names of all ancestral nodes are used to construct a uniform resource identifier (URI) for each node. Leaf nodes under “OPERATION” nodes indicate administrative control while all other leaf nodes indicate configuration control.

Node <X>310 is the placeholder node under which the administrative and configuration control for trigger processing may be accessed. Node <X>310 and its sub-nodes may be added to an existing management object or a new management object may be defined for this purpose.

WAP_CFG node 320 is associated with trigger processing capability through WAP. For WAP Push, only administrative control is supported for trigger processing, namely ALLOW and INHIBIT. This is because the address for SMS (i.e. phone number) is outside the configuration control of the DM server.

SIP_CFG node 330 is associated with trigger processing capability through SIP. Similar to WAP, administrative control is supported for SIP. In addition, configuration control over trigger processing in OMA DM is optional in SIP. That is, modifying the public identity of the client device, the globally routable user agent URI (GRUU), and the listening port (“PORTNUM”) is optional. This is because the GRUU is already assigned by a server when the client performs SIP registration, and SIP has a well defined port number ‘5060’ to which it defaults. Furthermore, the SIP GRUU allows one public and multiple temporary GRUUs for the same instance identifier (ID) and address-of-record (AOR). Accordingly, one leaf node is shown for “PUBLIC_GRUU”, and the parent node <X>* 335 of “TEMP_GRUU” indicates that there may be more occurrences.

UDP_CFG node 340 is associated with trigger processing capability through UDP. Similar to SIP, both administrative and configuration controls are available in UDP. However, configuration control of UDP requires the listening port number (“PORTNUM”) to be set affirmatively. While SIP binding may automatically default to port number ‘5060 ’, the port number for raw UDP binding needs to be agreed upon between the client device and the server. EXT node 340 is a placeholder node for proprietary extensions.

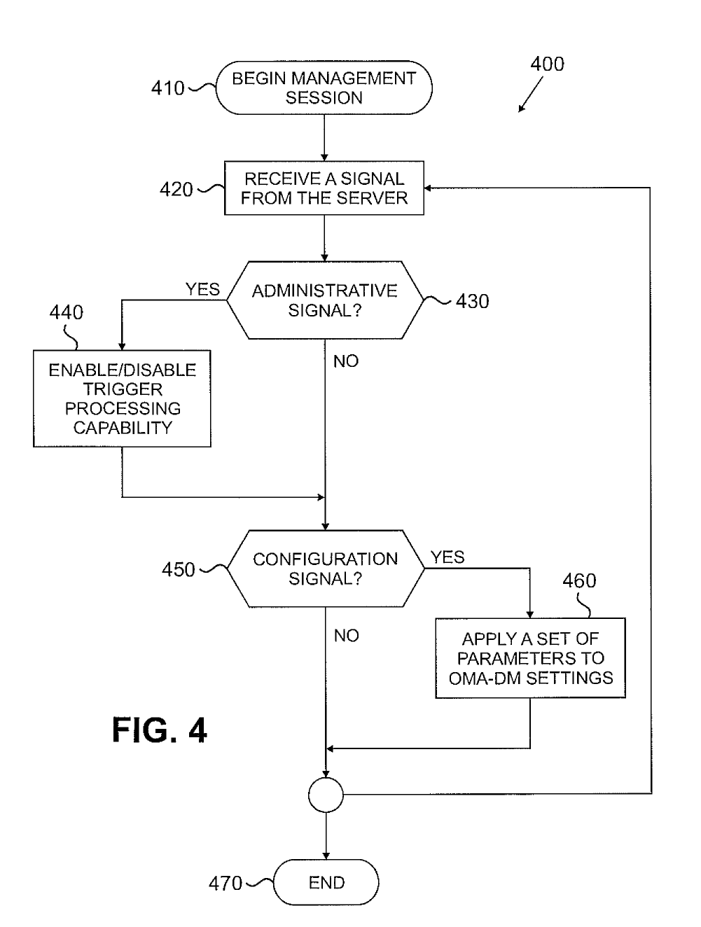

FIG. 4 illustrates a process 400 in a client device during a device management session according to an embodiment of the disclosure. The device management session may be an OMA DM session.

Block 410 indicates that the client device and the server have passed the setup phase and have successfully entered the management phase to engage in administrative and configuration control over trigger processing in the client device. The management session may be conducted in WAP, SIP, or UDP.

At block 420, the client device receives a signal from the server. At block 430, the client device determines whether the received signal includes an administrative signal. If the received signal includes an administrative signal, the client device, at block 440, allows or inhibits its trigger processing capability in accordance with the administrative signal. Once the trigger processing capability is inhibited, the client device will be inhibited from processing the trigger signal, such as trigger signal 212. That is, the client device may ignore trigger signals for the duration that the inhibition is in effect. The server is not necessarily limited to administrative control over the binding through which the current management session is taking place. Instead, the administrative signal may specify on or more bindings (i.e. WAP, SIP, UDP, and so forth) for which trigger processing is allowed or inhibited. Alternatively, the client device may inhibit trigger processing for the binding through which the current management session is taking place in the absence of binding specification in the administrative signal. For bindings in which trigger processing is inhibited, the client device may still initiate a management session either sporadically or periodically.

Referring back to block 430, the client device next determines whether the received signal includes a configuration signal at block 450. If the received signal includes a configuration signal, the client device applies a set of parameters to the corresponding configuration settings in the client device, such as the corresponding nodes of the management structure 300. Otherwise, the management session continues and processes another signal received or may end the management session.

The administrative signal and the configuration signal may be received through a management object interface or as a command. Furthermore, block 430 and block 450 may be performed simultaneously or in reverse order. In another embodiment, each received signal may contain either an administrative signal or a configuration signal but not both.

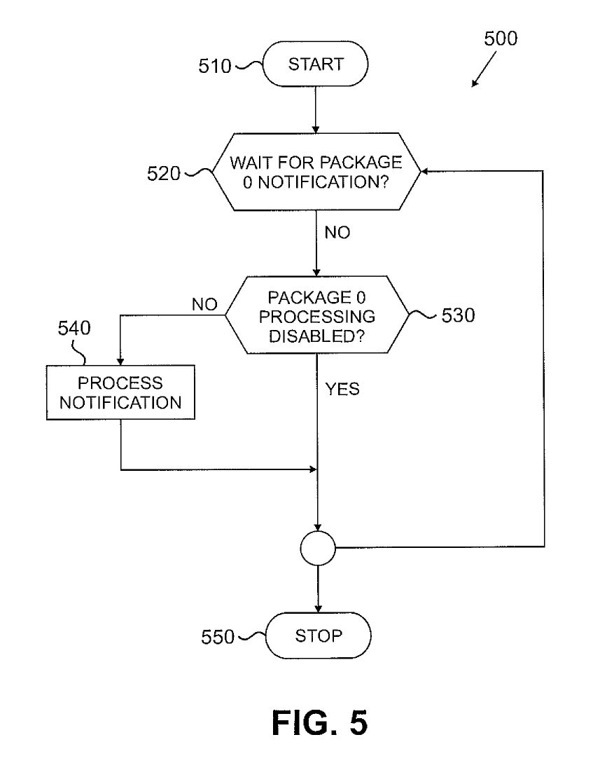

FIG. 5 illustrates a process 500 in which a client may ignore trigger signals according to an embodiment of the present disclosure.

At block 520, the client device waits for a trigger message, such as trigger signal 212. For SIP and UDP, the client device listens for the trigger signal 212 on a specific port. Upon receiving trigger signal 212, the client device determines whether trigger processing has been inhibited. That is, the client device determines whether trigger processing has been inhibited for the particular protocol through which trigger signal 212 was received. If trigger processing is inhibited, for that particular protocol, the client device ignores trigger signal 212 and continues with other processes or returns to wait for a trigger signal.

Alternatively, if trigger processing is not inhibited for the protocol through which trigger signal 212 was received, the client device processes the notification. That is, the client verifies whether the triggering server is a valid server with which the client device is allowed to conduct a management session. Upon successful verification, the client device enters setup phase 210. That is, the client device transmits client initialization message 214 and waits to receive server initialization message 216. Upon successful completion, the client and the server enter management phase 240.

The process illustrated in FIG. 5 is merely one embodiment of the present disclosure and is not meant to limit the essence of the present disclosure, namely the ability to inhibit trigger processing in a client device. In some embodiments the client device may not wait or listen for trigger signal 212 on a protocol for which trigger processing has been inhibited.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a device during a remote management session with a server, a method comprising:
receiving an administrative signal from the server; and
disabling a trigger processing capability in the device when the administrative signal notifies the device to inhibit the trigger processing capability.

2. The method of claim 1, further comprising:
receiving a configuration signal from the server; and
applying a set of parameters included in the configuration signal to the device settings that are related to controlling notification processing.

3. The method of claim 2, wherein the device settings are related to controlling notification processing based on Open Mobile Alliance (OMA) Push.

4. The method of claim 3, wherein the remote management session is an Open Mobile Alliance (OMA) Device Management (DM) session, and wherein trigger processing comprises initiating the OMA DM session.

5. The method of claim 2, wherein:
the set of parameters is applied to at least one of a session initiation protocol (SIP) configuration and user datagram protocol (UDP) configuration,
the SIP configuration comprises a port number, a temporary globally routable user agent uniform resource identifier (GRUU), and a public GRUU, and
the UDP configuration comprises a port number.

6. The method of claim 2, wherein the administration signal and the configuration signal are included in a combined signal received from the server.

7. The method of claim 2, further comprising modifying a management object based on the configuration signal.

8. The method of claim 2, wherein applying the set of parameters comprises configuring a set of corresponding nodes on a DM tree.

9. The method of claim 1, wherein the administrative signal specifies at least one transport binding over which the device is to inhibit trigger processing, and wherein the at least one transport binding comprises at least one of wireless application protocol (WAP), session initiation protocol (SIP), and user datagram protocol (UDP).

10. For use in a device capable of conducting a remote management session with a server, the device configured to:
receive an administrative signal from the server; and
inhibit a trigger processing capability in the device when the administrative signal notifies the device to inhibit the trigger processing capability.

11. The device of claim 10, wherein the device is further configured to:
receive a configuration signal from the server; and
apply a set of parameters included in the configuration signal to the device settings that are related to controlling notification processing.

12. The device of claim 11, wherein the device settings are related to controlling notification processing based on Open Mobile Alliance (OMA) Push.

13. The device of claim 12, wherein the remote management session is an Open Mobile Alliance (OMA) Device Management (DM) session, and wherein trigger processing comprises initiating the OMA DM session.

14. The device of claim 11, wherein:
the set of parameters is applied to at least one of a session initiation protocol (SIP) configuration and user datagram protocol (UDP) configuration,
the SIP configuration comprises a port number, a temporary globally routable user agent uniform resource identifier (GRUU), and a public GRUU, and
the UDP configuration comprises a port number.

15. The method of claim 11, wherein the administration signal and the configuration signal are included in a combined signal received from the server.

16. The method of claim 11, wherein the device is further configured to modify a management object based on the configuration signal.

17. The method of claim 11, wherein the device is further configured to configuring a set of corresponding nodes on a DM tree when applying the set of parameters.

18. The method of claim 10, wherein the administrative signal specifies at least one transport binding over which the device is to inhibit trigger processing and wherein the at least one transport binding comprises at least one of wireless application protocol (WAP), session initiation protocol (SIP), and user datagram protocol (UDP).

19. A method comprising:
receiving a signal at a device;
determining whether the signal is a trigger signal;
ignoring the trigger signal when the device is inhibited from processing the trigger signal; and
processing the trigger signal and initiating a management session when the device is set to process the trigger signal.

20. The method of claim 1, wherein the management session is an Open Mobile Alliance (OMA) Device Management (DM) session with a server, and wherein the trigger signal is a notification message based on OMA Push that prompts the device to initiate the OMA DM session.
